(19) United States
(12) Patent Application Publication
(10) Pub. No.: US 2025/0233310 A1
(43) Pub. Date: Jul. 17, 2025

(54) ELECTRONIC DEVICE

(71) Applicant: Advanced Semiconductor Engineering, Inc., Kaohsiung (TW)

(72) Inventors: Po-An LIN, Kaohsiung (TW); Shao-En HSU, Kaohsiung (TW)

(73) Assignee: Advanced Semiconductor Engineering, Inc., Kaohsiung (TW)

(21) Appl. No.: 18/415,637

(22) Filed: Jan. 17, 2024

(51) Int. Cl. H01Q 9/04; H01Q 1/22; H01Q 3/26; H01Q 21/29

(52) U.S. Cl. CPC H01Q 9/0414; H01Q 1/22; H01Q 21/29; H01Q 3/26

(57) ABSTRACT

An electronic device is disclosed. The electronic device includes a first pattern, a second pattern adjacent to the first pattern, and a third pattern disposed between the first pattern and the second pattern. The electronic device also includes a first feeding element and a second feeding element. The first feeding element is spaced apart from the first pattern and the third pattern and configured to electrically couple the first pattern and the third pattern to constitute a first antenna. The second feeding element is configured to electrically couple the second pattern and the third pattern to constitute a second antenna.

### BACKGROUND

### 1. Field of the Disclosure

The present disclosure generally relates to an electronic device.

### 2. Description of the Related Art

Existing Antenna-in-Package (AiP) antennas, such as patch antennas, possess a certain level of antenna gain, which can be further enhanced in an array design to support millimeter (mm) wave and/or sub-terahertz (sub-THz) communication systems. However, the bandwidth of patch antennas is limited. Using patch antennas for multiband communications necessitates an increase in package size and associated cost, potentially restricting their applicability in miniaturization.

### SUMMARY

In some arrangements, an electronic device includes a first pattern, a second pattern adjacent to the first pattern, and a third pattern disposed between the first pattern and the second pattern. The electronic device also includes a first feeding element and a second feeding element. The first feeding element is spaced apart from the first pattern and the third pattern and configured to electrically couple the first pattern and the third pattern to constitute a first antenna. The second feeding element is configured to electrically couple the second pattern and the third pattern to constitute a second antenna.

In some arrangements, an electronic device includes a first pattern connected to a grounding element, a second pattern adjacent to the first pattern, and a third pattern adjacent to the first pattern. The first pattern and the second pattern are configured to constitute a first antenna. The first pattern and the third pattern are configured to constitute a second antenna. The first antenna and the second antenna are configured to constitute a beamforming antenna structure.

In some arrangements, an electronic device includes a first magneto-electric (ME) dipole antenna having a conductive pattern, and a second magneto-electric (ME) dipole antenna. The conductive pattern configured to serve as a portion of the second ME dipole antenna.

### BRIEF DESCRIPTION OF THE DRAWINGS

Aspects of some arrangements of the present disclosure are best understood from the following detailed description when read with the accompanying figures. It is noted that various structures may not be drawn to scale, and dimensions of the various structures may be arbitrarily increased or reduced for clarity of discussion.

FIG. 1A is a perspective view of an electronic device, in accordance with an arrangement of the present disclosure.

FIG. 1B is a top view of an electronic device, in accordance with an arrangement of the present disclosure.

FIG. 1C is a cross-section of an electronic device, in accordance with an arrangement of the present disclosure.

FIG. 1C′ is a cross-section of an electronic device, in accordance with an arrangement of the present disclosure.

FIG. 1D is a cross-section of an electronic device, in accordance with an arrangement of the present disclosure.

FIG. 1D′ is a cross-section of an electronic device, in accordance with an arrangement of the present disclosure.

FIG. 1E is a cross-section of an electronic device, in accordance with an arrangement of the present disclosure.

FIG. 1F shows current distribution of an electronic device, in accordance with an arrangement of the present disclosure.

FIG. 1G is a top view of an electronic device, in accordance with an arrangement of the present disclosure.

FIG. 1H is a top view of an electronic device, in accordance with an arrangement of the present disclosure.

FIG. 1I is a top view of an electronic device, in accordance with an arrangement of the present disclosure.

FIG. 2A is a top view of an electronic device, in accordance with an arrangement of the present disclosure.

FIG. 2B is a top view of an electronic device, in accordance with an arrangement of the present disclosure.

FIG. 2C is a top view of an electronic device, in accordance with an arrangement of the present disclosure.

FIG. 2D is a perspective view of an electronic device, in accordance with an arrangement of the present disclosure.

FIG. 3A is a top view of an electronic device, in accordance with an arrangement of the present disclosure.

FIG. 3B is a top view of an electronic device, in accordance with an arrangement of the present disclosure.

FIG. 3C is a top view of an electronic device, in accordance with an arrangement of the present disclosure.

FIG. 3D is a top view of an electronic device, in accordance with an arrangement of the present disclosure.

FIG. 4A is a simulated antenna gain pattern of an electronic device, in accordance with an arrangement of the present disclosure.

FIG. 4B is a simulated graph of antenna gain (in dB) versus frequency of an electronic device, in accordance with an arrangement of the present disclosure.

### DETAILED DESCRIPTION

Common reference numerals are used throughout the drawings and the detailed description to indicate the same or similar components. Arrangements of the present disclosure will be readily understood from the following detailed description taken in conjunction with the accompanying drawings.

The following disclosure provides many different arrangements, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include arrangements in which the first and second features are formed or disposed in direct contact, and may also include arrangements in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various arrangements and/or configurations discussed.

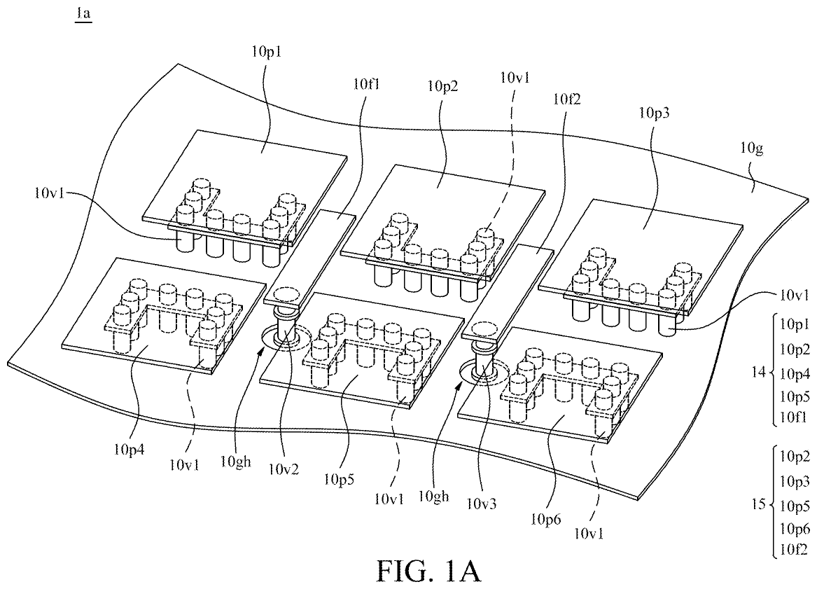

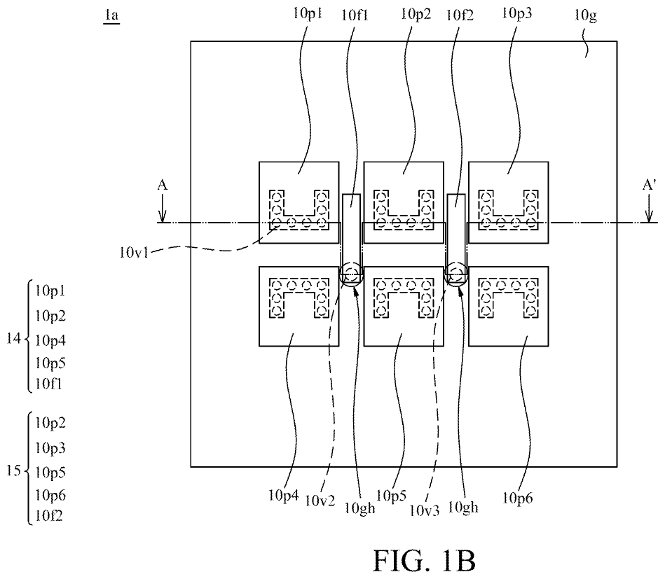

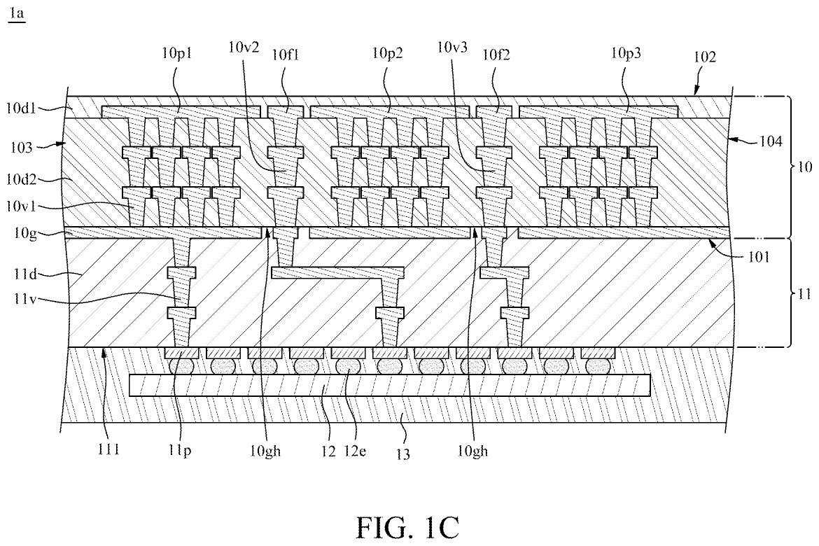

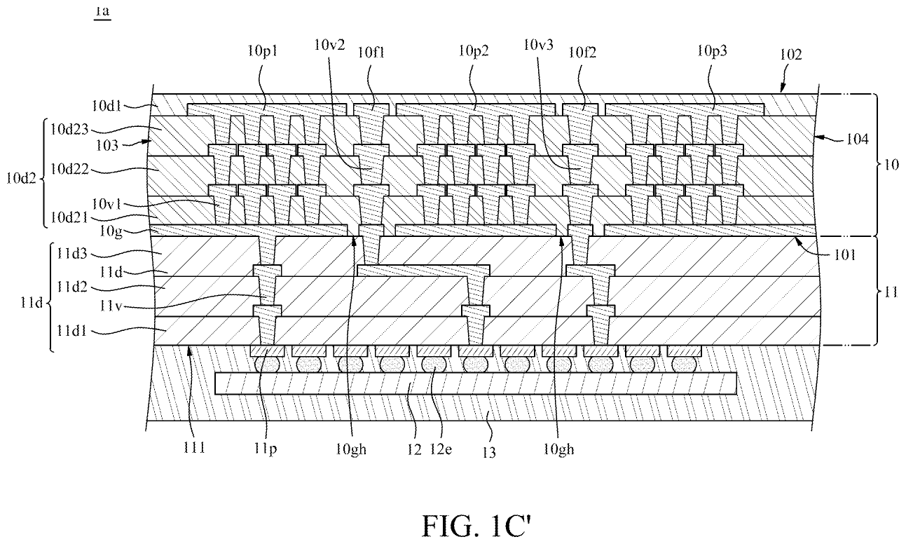

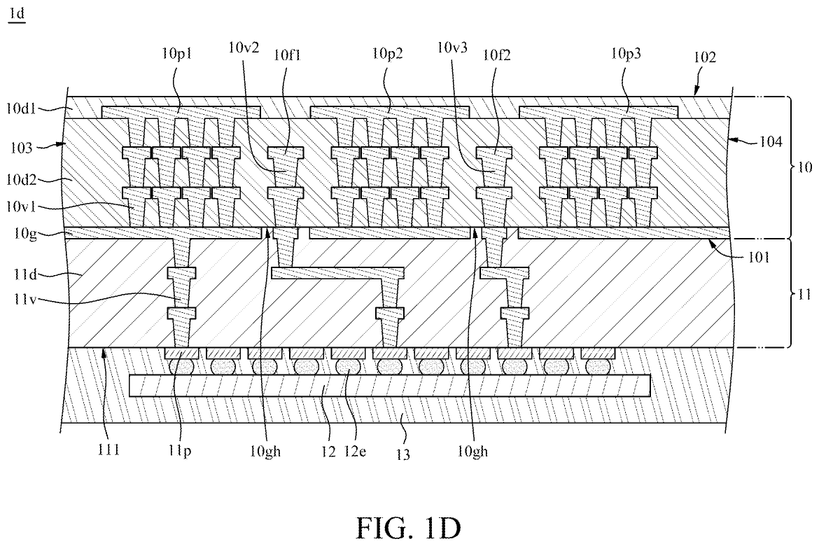

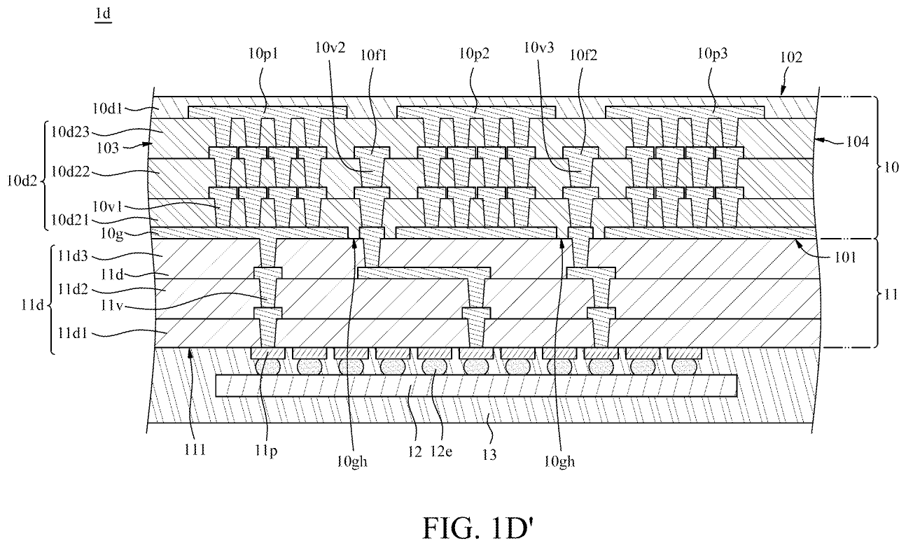

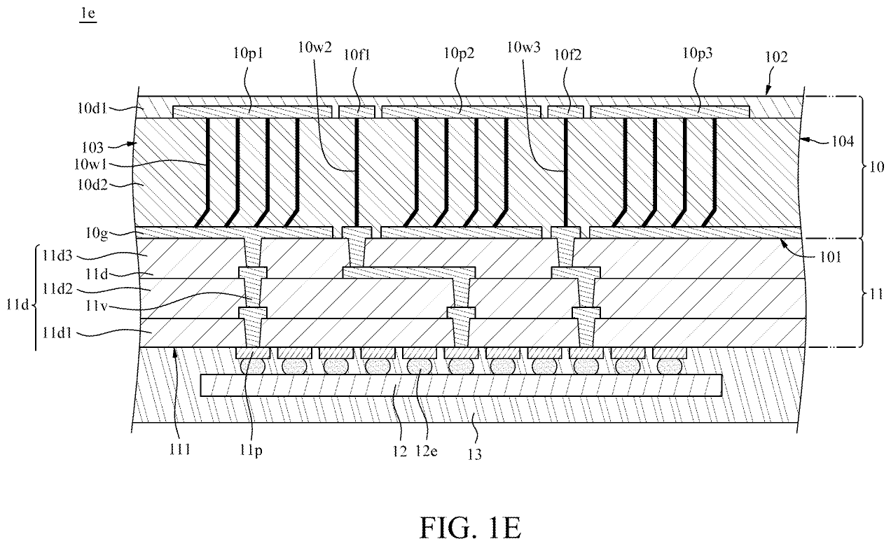

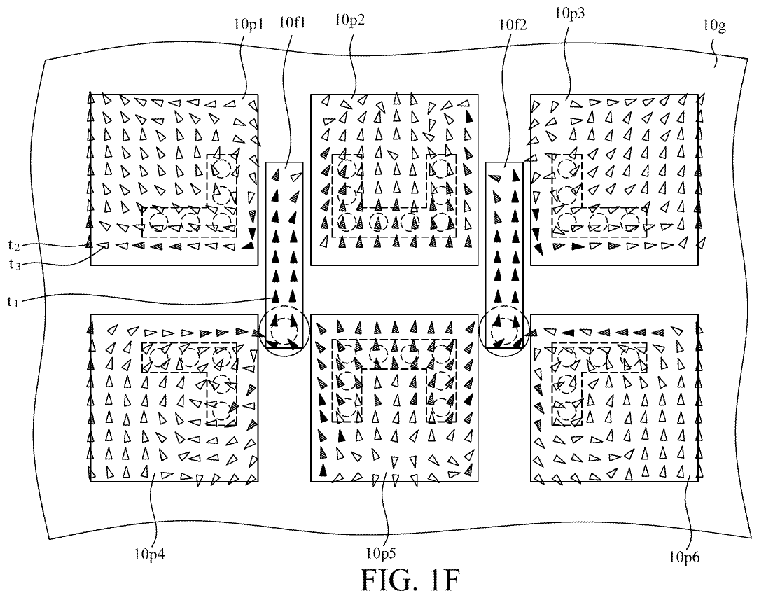

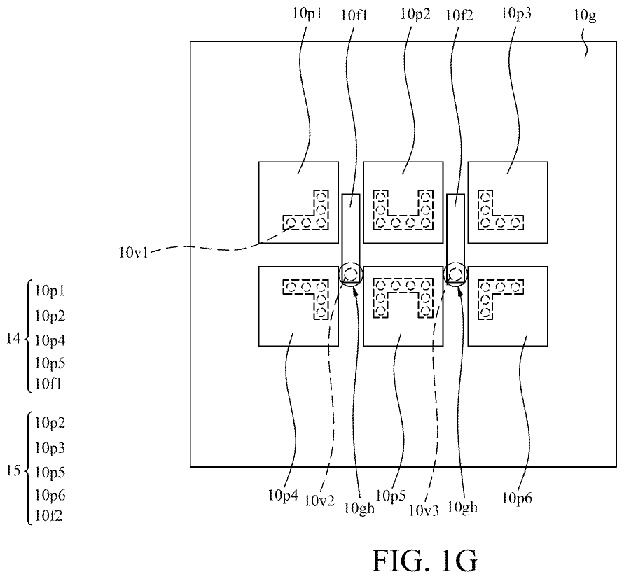

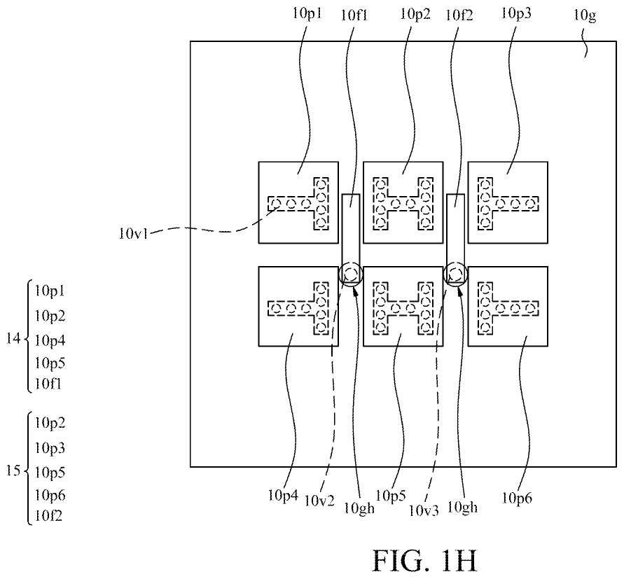

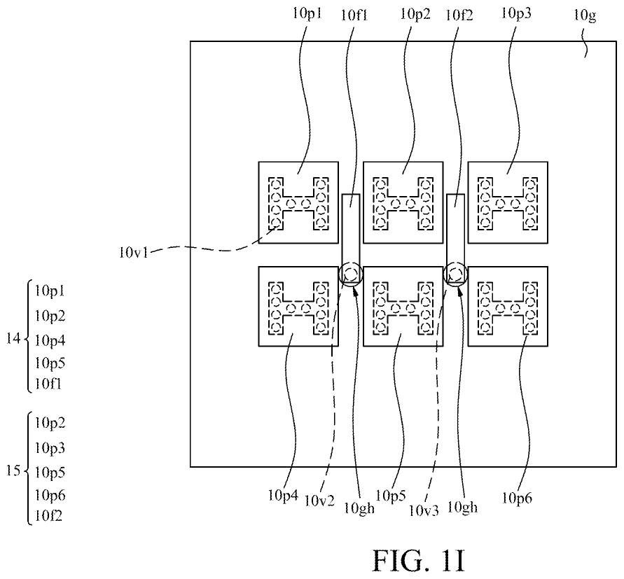

FIG. 1A is a perspective view of an electronic device 1a, in accordance with an arrangement of the present disclosure. In some arrangements, the electronic device 1a may be or include, for example, an antenna device or an antenna package. In some arrangements, the electronic device 1a may be or include, for example, a wireless device, such as user equipment (UE), a mobile station, a mobile device, an apparatus communicating with the Internet of Things (IoT), etc. In some arrangements, the electronic device 1a may be or include a portable device.

The electronic device 1a may include a grounding plane 10g, patterns 10p1, 10p2, 10p3, 10p4, 10p5, and 10p6, feeding elements 10f1 and 10f2, and conductive vias 10v1, 10v2, and 10v3.

The patterns 10p1, 10p2, 10p3, 10p4, 10p5, and 10p6 may also be referred to as conductive elements, antenna elements, or radiation elements. The patterns 10p1, 10p2, 10p3, 10p4, 10p5, and 10p6 may be configured to radiate and/or receive electromagnetic (EM) waves/signals, such as radio waves, microwaves, infrared waves, X-rays, gamma rays, etc. The patterns 10p1, 10p2, 10p3, 10p4, 10p5, and 10p6 may be configured to operate at any desirable frequency (frequency band and/or bandwidth) to support fifth generation (5G) communications, beyond-5G communications, and/or 6G communications. For example, the patterns 10p1, 10p2, 10p3, 10p4, 10p5, and 10p6 may be configured to operate at microwave frequency bands, Sub-6 GHz frequency bands, 5 GHz frequency bands, terahertz (THz) frequency bands, etc.

The patterns 10p1, 10p2, 10p3, 10p4, 10p5, and 10p6 may each be electrically coupled to the grounding plane 10g through the conductive vias 10v1. The conductive vias 10v1 may perpendicularly intersect with the patterns 10p1, 10p2, 10p3, 10p4, 10p5, and 10p6. As used herein, the term “couple” is used to describe two electric circuits brought into sufficient proximity to permit mutual influence, inductive coupling, energy coupling, etc.

Although eight conductive vias 10v1 connect to each of the patterns 10p1, 10p2, 10p3, 10p4, 10p5, and 10p6, the number of conductive vias 10v1 is not limited thereto. In some arrangements, there may be any number of conductive vias 10v1 depending on design requirements.

By electrically coupling the patterns 10p1, 10p2, 10p3, 10p4, 10p5, and 10p6 to the grounding plane 10g (which may be referred to as a grounding element), interference between the feeding elements 10f1 and 10f2 can be reduced, which can help improve antenna performance of the electronic device 1a. In addition, the grounding plane 10g may reflect the EM waves emitted by the patterns 10p1, 10p2, 10p3, 10p4, 10p5, and 10p6, which helps increase radiation efficiency and directivity of the electronic device 1a. In some arrangements, the grounding plane 10g may help improve impedance matching by providing a ground potential or a reference point for the radiation and reducing mismatch loss.

The patterns 10p1, 10p2, 10p4, and 10p5 and the feeding element 10f1 may be a part of an antenna 14. The patterns 10p1, 10p2, 10p4, and 10p5 and the feeding element 10f1 may be collectively configured to form or constitute the antenna 14. The antenna 14 may include a magneto-electric (ME) dipole antenna.

For example, the patterns 10p1, 10p2, 10p4, and 10p5 may be the electric dipoles of the antenna 14. The conductive vias 10v1 connecting the patterns 10p1, 10p2, 10p4, and 10p5 may be the magnetic dipoles of the antenna 14. The electric dipoles and magnetic dipoles of a ME dipole antenna work together to radiate EM waves and facilitate communication. This configuration makes a ME dipole antenna suitable for a wide range of applications, including wireless communication, radar, and sensing systems.

The patterns 10p1, 10p2, 10p4, and 10p5 may include or be arranged in a 2×2 array. The feeding element 10f1 may be disposed at the center of the patterns 10p1, 10p2, 10p4, and 10p5. The patterns 10p1, 10p2, 10p4, and 10p5 may be symmetrically arranged around the feeding element 10f1. The patterns 10p1, 10p2, 10p4, and 10p5 may be evenly spaced apart from the feeding element 10f1. The feeding element 10f1 may be disposed between the patterns 10p1 and 10p2 and between the patterns 10p4 and 10p5.

The feeding element 10f1 may be electrically coupled to an electronic component (such as the electronic component 12 in FIG. 1C) through the conductive via 10v2. The conductive via 10v2 may perpendicularly intersect with the feeding element 10f1, with the midpoint of the intersection being the feed point. The conductive via 10v2 may be disposed in an opening 10gh of the grounding plane 10g. The conductive via 10v2 may be spaced apart from the grounding plane 10g. The patterns 10p1, 10p2, 10p4, and 10p5 may be capable of being excited by the feeding element 10f1.

The patterns 10p2, 10p3, 10p5, and 10p6 and the feeding element 10f2 may be a part of an antenna 15. The patterns 10p2, 10p3, 10p5, and 10p6 and the feeding element 10f2 may be collectively configured to form or constitute the antenna 15. The antenna 15 may include a ME dipole antenna.

For example, the patterns 10p2, 10p3, 10p5, and 10p6 may be the electric dipoles of the antenna 15. The conductive vias 10v1 connecting the patterns 10p2, 10p3, 10p5, and 10p6 may be the magnetic dipoles of the antenna 15.

The patterns 10p2, 10p3, 10p5, and 10p6 may include or be arranged in a 2×2 array. The feeding element 10f2 may be disposed at the center of the patterns 10p2, 10p3, 10p5, and 10p6. The patterns 10p2, 10p3, 10p5, and 10p6 may be symmetrically arranged around the feeding element 10f2. The 10p2, 10p3, 10p5, and 10p6 may be evenly spaced apart from the feeding element 10f2. The feeding element 10f2 may be disposed between the patterns 10p2 and 10p3 and between the patterns 10p5 and 10p6.

The feeding element 10f2 may be electrically coupled to an electronic component (such as the electronic component 12 in FIG. 1C) through the conductive via 10v3. The conductive via 10v3 may perpendicularly intersect with the feeding element 10f2, with the midpoint of the intersection being the feed point. The conductive via 10v3 may be disposed in an opening 10gh of the grounding plane 10g. The conductive via 10v3 may be spaced apart from the grounding plane 10g. The patterns 10p2, 10p3, 10p5, and 10p6 may be capable of being excited by the feeding element 10f2.

The antenna 14 and the antenna 15 may include common patterns. The antenna 14 and the antenna 15 may share common patterns. For example, pattern 10p2 and pattern 10p5 may be common patterns of the antenna 14 and the antenna 15. For example, pattern 10p2 and pattern 10p5 may be shared by the antenna 14 and the antenna 15. For example, pattern 10p2 and pattern 10p5 may both be part of the antenna 14 and of the antenna 15. For example, pattern 10p2 and pattern 10p5 may both be capable of being excited by the feeding element 10f1. For example, pattern 10p2 and pattern 10p5 may both be capable of being excited by the feeding element 10f2.

The antenna 14 and the antenna 15 may be of the same or similar structure. In some arrangements, the distance or spacing between the feeding elements 10f1 and 10f2 may be a fraction of the wavelength of the operating frequency, such as from 0.2λ to 0.3λ. In some arrangements, the distance or spacing between the feeding elements 10f1 and 10f2 may be less than a half-wavelength of the operating frequency. As stated, by electrically coupling the patterns 10p1, 10p2, 10p3, 10p4, 10p5, and 10p6 to the grounding plane 10g, interference between the feeding elements 10f1 and 10f2 can be reduced.

In some arrangements, the grounding plane 10g, the plurality of patterns 10p1, 10p2, 10p3, 10p4, 10p5, and 10p6, the feeding elements 10f1 and 10f2, and the conductive vias 10v1, 10v2, and 10v3 may each include a conductive material such as metal or metal alloy. Examples of the conductive material may include, but are not limited to, gold (Au), silver (Ag), copper (Cu), platinum (Pt), Palladium (Pd), other metals or alloys, or a combination thereof.

In some arrangements, the antenna 14 and the antenna 15 may form a beamforming antenna structure. The antenna 14 and the antenna 15 may create a focused and directional beam of EM waves. For example, the antenna 14 and the antenna 15 may create constructive interference in the desired direction by adjusting the phase and amplitude thereof. In some arrangements, the antenna 14 and the antenna 15 may create constructive interference in a far field region. In some arrangements, the antenna 14 and the antenna 15 may have far field interference. In the case of far field interference, the EM waves have already traveled a significant distance from their sources, and their wavefronts have become nearly planar. As a result, the interference patterns formed in the far field region may be relatively stable and predictable.

FIG. 1B is a top view of the electronic device 1a, in accordance with an arrangement of the present disclosure.

Some or all of the patterns 10p1, 10p2, 10p3, 10p4, 10p5, and 10p6 may be of the same or similar shape. Some or all of the patterns 10p1, 10p2, 10p3, 10p4, 10p5, and 10p6 may be geometrically similar. Some or all of the patterns 10p1, 10p2, 10p3, 10p4, 10p5, and 10p6 may be circular, rectangular, ovoid, semicircular, pentagonal, hexagonal, heptagonal, octagonal, etc. The feed element 10f1 may have a first portion adjacent to a side (or a lateral side) of the pattern 10p1, and a second portion connected to the first portion and extending from it to exceed a lateral side of the pattern 10p1. The second portion may also extend exceed a lateral side of the pattern 10p4. For example, the feed element 10f1 may extend between the patterns 10p1 and 10p4.

The conductive vias 10v1 may be arranged along the lateral side, external surface, edge, or boundary of each of the patterns 10p1, 10p2, 10p3, 10p4, 10p5, and 10p6. The conductive vias 10v1 may be arranged along three sides of each of the patterns 10p1, 10p2, 10p3, 10p4, 10p5, and 10p6. However, in some arrangements, the conductive vias 10v1 may be arranged along one side, two sides, or four sides of each of the patterns 10p1, 10p2, 10p3, 10p4, 10p5, and 10p6.

The conductive via 10v2 may be disposed near to a side or an end of the feeding element 10f1. For example, the conductive via 10v2 may be in proximity to one of a side and an end of the feed element 10f1. In some arrangements, the conductive via 10v2 may be disposed at the center of the feeding element 10f1. The conductive via 10v3 may be disposed near to a side or an end of the feeding element 10f2. For example, the conductive via 10v3 may be in proximity to one of a side and an end of the feed element 10f2. In some arrangements, the conductive via 10v3 may be disposed at the center of the feeding element 10f2. For example, the feed element 10f1 may have a portion extending exceed a lateral side of the pattern 10p1, and the conductive via 10v2 may be connected with the portion. For example, the feed element 10f1 may have a portion extending exceed a lateral side of the pattern 10p4, and the conductive via 10v2 may be connected with the portion.

FIG. 1C is a cross-section of the electronic device 1a, in accordance with an arrangement of the present disclosure. In some arrangements, FIG. 1C may be a cross-section through line AA′ of FIG. 1B. FIG. 1C′ is a cross-section of the electronic device 1a, in accordance with an arrangement of the present disclosure. In some arrangements, FIG. 1C′ may be a cross-section through line AA′ of FIG. 1B.

The electronic device 1a may also include a radiating structure 10, a circuit structure 11, an electronic component 12, and an encapsulant 13.

The radiating structure 10 may be capable of operating at multiple frequencies (frequency bands and/or bandwidths). For example, the radiating structure 10 may be configured to operate at a relatively higher frequency (a relatively higher frequency band and/or bandwidth) and a relatively lower frequency (a relatively lower frequency band and/or bandwidth). For example, the radiating structure 10 may be configured to radiate and/or receive an EM wave having a relatively higher frequency and an EM wave having a relatively lower frequency. In some arrangements, the radiating structure 10 may be capable of radiating and/or receiving an EM wave having a relatively higher frequency and an EM wave having a relatively lower frequency in parallel.

The radiating structure 10 may include a surface 101, a surface 102 opposite to the surface 101, and lateral surfaces (or sidewalls) 103, 104 extending between the surfaces 101 and 102. The surface 101 and/or the surface 102 of the radiating structure 10 may be parallel to the xy-plane. The radiating structure 10 may include an antenna layer (where the patterns 10p1, 10p2, 10p3, 10p4, 10p5, and 10p6, and the feeding elements 10f1 and 10f2 in FIGS. 1A and 1B are located), the grounding plane 10g, dielectric layers 10d1, 10d2, and conductive vias 10v1, 10v2, and 10v3. In some arrangements, as shown in FIG. 1C′, the dielectric layers 10d2 may include a multi-layer structure, which has several layers 10d21, 10d22, and 10d23.

The antenna layer may be adjacent to the surface 102 of the radiating structure 10. Although there is one antenna layer in FIG. 1C, the number of antenna layers is not limited thereto. In some arrangements, there may be any number of antenna layers depending on design requirements.

The antenna layer may be partially or fully within (or covered by) the dielectric layers 10d1. In some arrangements, an upper surface (not annotated in the figures) of the patterns 10p1, 10p2, 10p3 may be exposed by the dielectric layers 10d1 and exposed on the surface 102 of the radiating structure 10.

The grounding plane 10g may be adjacent to the surface 101 of the radiating structure 10. The grounding plane 10g may be disposed under the antenna layer (where the patterns 10p1, 10p2, 10p3, 10p4, 10p5, and 10p6, and the feeding elements 10f1 and 10f2 in FIGS. 1A and 1B are located). Although there is one grounding plane in FIG. 1C, the number of grounding planes is not limited thereto. In some arrangements, there may be any number of grounding planes depending on design requirements. The grounding plane 10g may be partially or fully within (or covered by) the dielectric layers 10d2.

Grounding plane 10g and the antenna layer may at least partially overlap to each other in a direction substantially perpendicular to the surface 101 and/or the surface 102 of the radiating structure 10. For example, a vertical projection of pattern 10p1 may be within the boundary of the grounding plane 10g. For example, a vertical projection of pattern 10p2 may be within the boundary of the grounding plane 10g. For example, a vertical projection of pattern 10p3 may be within the boundary of the grounding plane 10g.

The conductive vias 10v1, 10v2, and 10v3 may be electrically coupled between the antenna layer and the grounding plane 10g. Although three conductive vias are stacked above the grounding plane 10g in FIG. 1C, the number of stacked conductive vias is not limited thereto. In some arrangements, there may be any number of stacked conductive vias depending on design requirements.

The feeding elements 10f1 and 10f2 may be located at the same horizontal level as the patterns 10p1, 10p2, and 10p3. For example, the feeding elements 10f1 and 10f2 may be located at the same elevation as the patterns 10p1, 10p2, and 10p3 with respect to the surface 111 of the circuit structure 11. For example, the feeding elements 10f1 and 10f2 may be located at the same elevation as the patterns 10p1, 10p2, and 10p3 with respect to the grounding plane 10g. The feeding element 10f1 may not be vertically overlapped with the patterns 10p1 and 10p2. The feeding element 10f1 may not be overlapped with the patterns 10p1 and 10p2 in a direction substantially perpendicular to the surface 111 of the circuit structure 11. The feeding element 10f2 may not be vertically overlapped with the patterns 10p2 and 10p3. The feeding element 10f2 may not be overlapped with the patterns 10p2 and 10p3 in a direction substantially perpendicular to the surface 111 of the circuit structure 11.

The conductive vias 10v1, 10v2, and 10v3 may be covered, encapsulated, or surrounded by the dielectric layers 10d2. In some arrangements, the dielectric layers 10d1 and 10d2 may include pre-impregnated composite fibers (e.g., pre-preg), ceramic-filled polytetrafluoroethylene (PTFE) composites, Borophosphosilicate Glass (BPSG), silicon oxide, silicon nitride, silicon oxynitride, Undoped Silicate Glass (USG), any combination thereof, or the like. Examples of a pre-preg may include, but are not limited to, a multilayer structure formed by stacking or laminating a number of pre-impregnated materials/sheets. In some arrangements, the dielectric layers 10d1 and 10d2 may include the same materials as the encapsulant 13.

The circuit structure 11 may be disposed adjacent to the surface 101 of the radiating structure 10. The circuit structure 11 may be disposed over or on the surface 101 of the radiating structure 10. The circuit structure 11 may be disposed under the radiating structure 10. The circuit structure 11 may contact (such as directly contact) the grounding plane 10g of the radiating structure 10. The grounding plane 10g may be disposed between the circuit structure 11 and antenna layer (where the patterns 10p1, 10p2, 10p3, 10p4, 10p5, and 10p6, and the feeding elements 10f1 and 10f2 are located). The grounding plane 10g may be configured to alleviate electromagnetic interference (EMI) on the circuit structure 11.

In some arrangements, the circuit structure 11 may be or include, for example, a substrate. In some arrangements, the circuit structure 11 may include, for example, a printed circuit board (PCB), such as a paper-based copper foil laminate, a composite copper foil laminate, or a polymer-impregnated glass-fiber-based copper foil laminate. In some arrangements, the circuit structure 11 may include a dielectric layer 11d, which may include a dielectric material stated above with respect to the dielectric layers 10d1 and 10d2. In some arrangements, as shown in FIG. 1C′, the dielectric layer 11d may include a multi-layer structure, which has several layers 11d1, 11d2, and 11d3.

In some arrangements, the circuit structure 11 may include conductive pads, traces, vias, layers, other conductive elements, or other interconnections. For example, the circuit structure 11 may include one or more transmission lines or communications cables. For example, the circuit structure 11 may include one or more conductive pads 11p in proximity to, adjacent to, or embedded in and exposed by a surface 111 of the circuit structure 11.

For example, the circuit structure 11 may include one or more conductive vias 11v. In some arrangements, the conductive vias 11v may be disposed over or on the surface 111 and electrically couple the conductive pads 11p on the surface 111. The conductive vias 11v may be covered by the dielectric material of the circuit structure 11. Some of the conductive vias 11v may be electrically coupled to the feeding elements 10f1 and 10f2. Some of the conductive vias 11v may be electrically coupled to the grounding plane 10g. In some arrangements, the conductive vias 11v may provide a feed signal to the ME dipole antennas (such as the antennas 14 and 15 in FIG. 1A) of the radiating structure 10 through the feeding elements 10f1 and 10f2.

The electronic component 12 may be disposed over or on the surface 111 of the circuit structure 11. The electronic component 12 may be electrically connected to one or more other electrical components (if any) and to the circuit structure 11 (e.g., to the interconnections), and the electrical connection may be attained by way of flip-chip, wire-bond techniques, metal to metal bonding (such as Cu to Cu bonding), or hybrid bonding. In some arrangements, the electronic component 12 may be electrically connected to the circuit structure 11 through one or more conductive elements (or electrical contacts) 12e. In some arrangements, the conductive elements 12e may include a controlled collapse chip connection (C4) bump, a ball grid array (BGA) or a land grid array (LGA).

The electronic component 12 may be a chip or a die including a semiconductor substrate, one or more integrated circuit (IC) devices, and one or more overlying interconnection structures therein. The IC devices may include active devices such as transistors and/or passive devices such as resistors, capacitors, inductors, or a combination thereof. For example, the electronic component 12 may include a system on chip (SoC). For example, the electronic component 12 may include a radio frequency integrated circuit (RFIC), an application-specific IC (ASIC), a central processing unit (CPU), a microprocessor unit (MPU), a graphics processing unit (GPU), a microcontroller unit (MCU), a field-programmable gate array (FPGA), or another type of IC.

In some arrangements, the electronic component 12 may be an RF signal generator or transmitter. In some arrangements, the electronic component 12 may be configured to generate EM waves that are fed into the ME dipole antenna in the radiating structure 10, which in turn radiates the signal into the surrounding space. The electronic component 12 may be configured to adjust the frequency, amplitude, and other parameters of the feeding signal to optimize the performance of the ME dipole antenna. Although there is one electronic component in FIG. 1C, the number of electronic components is not limited thereto. In some arrangements, there may be any number of electronic components depending on design requirements.

The encapsulant 13 may be disposed over or on the surface 111 of the circuit structure 11 to cover the electronic component 12. The encapsulant 13 may include insulation or dielectric material. In some arrangements, the encapsulant 13 may include an epoxy resin having fillers, a molding compound (e.g., an epoxy molding compound or other molding compound), a polyimide, a phenolic compound or material, a material with a silicone dispersed therein, or a combination thereof. In some arrangements, the dielectric layers 10d2 may include an epoxy resin having fillers, a molding compound (e.g., an epoxy molding compound or other molding compound), a polyimide, a phenolic compound or material, a material with a silicone dispersed therein, or a combination thereof. In some arrangements, the dielectric constant (Dk value) of the dielectric layers 10d2 may be different from the Dk value of the encapsulant 13. For example, the Dk value of the dielectric layers 10d2 may be greater than the Dk value of the encapsulant 13. For example, the Dk value of the dielectric layers 10d2 may be less than the Dk value of the encapsulant 13.

FIG. 1D is a cross-section of an electronic device 1d, in accordance with an arrangement of the present disclosure. FIG. 1D′ is a cross-section of an electronic device 1d, in accordance with an arrangement of the present disclosure. The electronic device 1d is similar to the electronic device 1a in FIG. 1C, with differences therebetween as follows.

The feeding elements 10f1 and 10f2 may be located at a different horizontal levels with respect to the patterns 10p1, 10p2, and 10p3. For example, the feeding elements 10f1 and 10f2 may be located at a lower elevation than the patterns 10p1, 10p2, and 10p3 with respect to the surface 111 of the circuit structure 11. For example, the feeding elements 10f1 and 10f2 may be located at a lower elevation than the patterns 10p1, 10p2, and 10p3 with respect to the grounding plane 10g. For example, the feeding elements 10f1 and 10f2 may be separated from the patterns 10p1, 10p2, and 10p3 vertically.

By separating the feeding elements 10f1 and 10f2 from the patterns 10p1, 10p2, and 10p3 vertically, a more compact design is provided which can help reduce the overall size of the electronic device 1d. Additionally, separating the feeding elements 10f1 and 10f2 from the patterns 10p1, 10p2, and 10p3 vertically can also help to reduce mutual coupling and improve isolation between the elements, which can lead to better overall antenna performance. In some arrangements, the feeding elements 10f1 and 10f2 may be disposed at different elevations with respect to the surface 111 of the circuit structure 11 (or the grounding plane 10g). For example, the feeding element 10f1 may be located at a lower elevation than the feeding element 10f2 with respect to the surface 111 of the circuit structure 11 (or the grounding plane 10g).

FIG. 1E is a cross-section of an electronic device 1e, in accordance with an arrangement of the present disclosure. The electronic device 1e is similar to the electronic device 1a in FIG. 1C, with differences therebetween as follows.

The conductive vias 10v1, 10v2, and 10v3 may be replaced with conductive wires 10w1, 10w2, and 10w3. In some arrangements, the conductive vias 10v1, 10v2, and 10v3 may be replaced with other conductive elements. The conductive elements may include, for example, a conductive pillar, conductive paste, conductive filler, solder material, or other suitable elements. The conductive elements may be chosen based on factors of the EM waves, which may including resonant frequency, impedance, admittance (the reciprocal of impedance), phase, wavelength, etc. The conductive wires 10w1, 10w2, and 10w3 may include vertical bonding wires or vertical conductive wires. In some arrangements, the dielectric layers 10d2 may include an epoxy resin having fillers, a molding compound (e.g., an epoxy molding compound or other molding compound), a polyimide, a phenolic compound or material, a material with a silicone dispersed therein, or a combination thereof.

FIG. 1F shows current distribution of the electronic device 1a, in accordance with an arrangement of the present disclosure.

The all-black vector t1 represents a magnetic field between 240 and 300 A/m (ampere per meter), the striped vector t2 represents a magnetic field between 120 and 210 A/m, and the all-white vector t3 represents a magnetic field between 0 and 90 A/m. To reduce interference between the feeding elements 10f1 and 10f2, the patterns 10p1, 10p2, 10p3, 10p4, 10p5, and 10p6 are electrically coupled to the grounding plane 10g. It is shown that currents on the feeding elements 10f1 and 10f2 flow substantially up and down, such that current intensity is greater in upward and downward and lateral interference (left and right directions, i.e., between the feeding elements 10f1 and 10f2) is reduced. In some arrangements, the interference between the patterns 10p1 and 10p3 may be reduced. In some arrangements, the interference between the patterns 10p4 and 10p6 may be reduced. In some arrangements, the interference between the antennas 14 and 15 may be reduced. This results in a more efficient and effective radiation pattern for the antenna (e.g., the ME dipole antenna) of the electronic device 1a, as the electric and magnetic fields work together to propagate the electromagnetic waves.

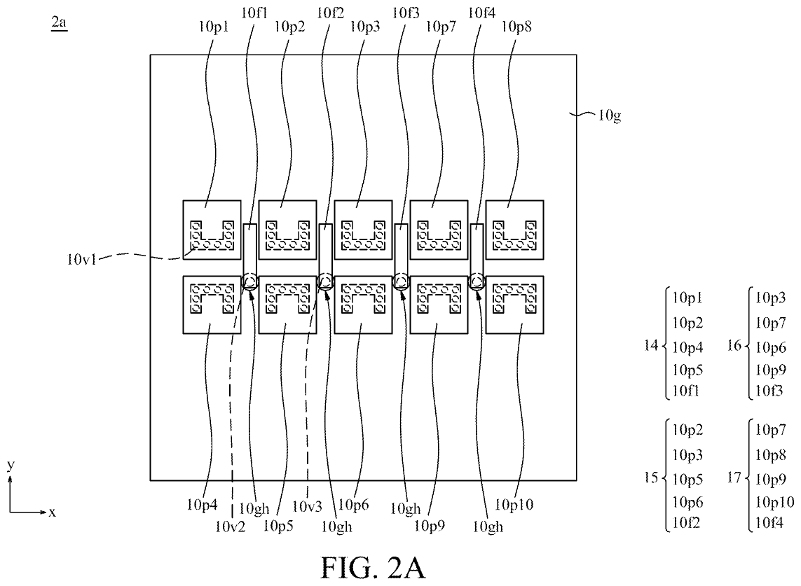

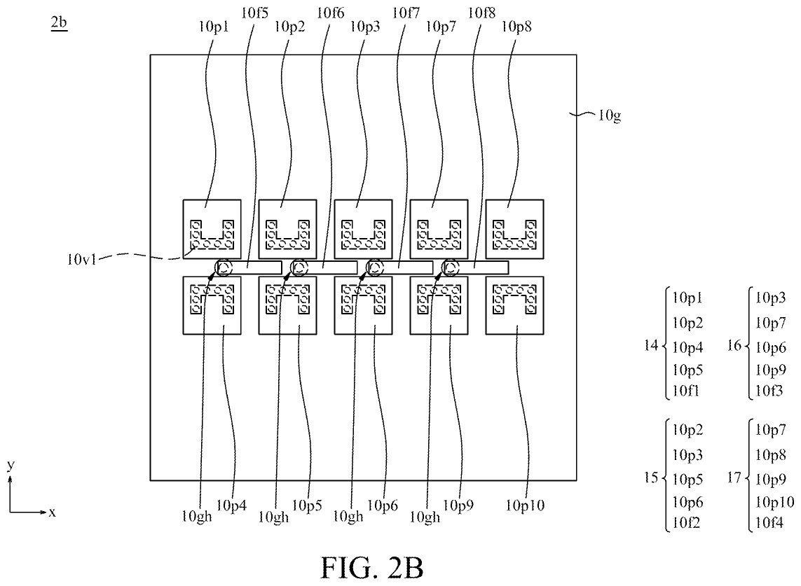

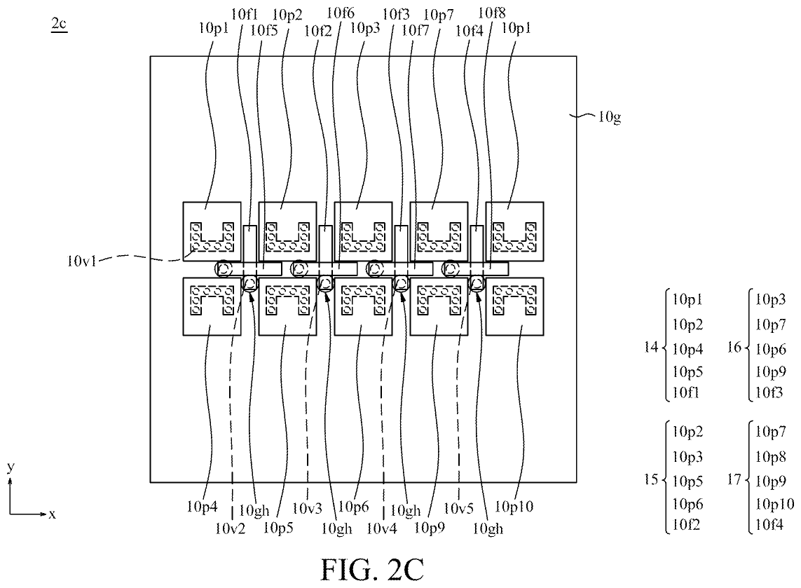

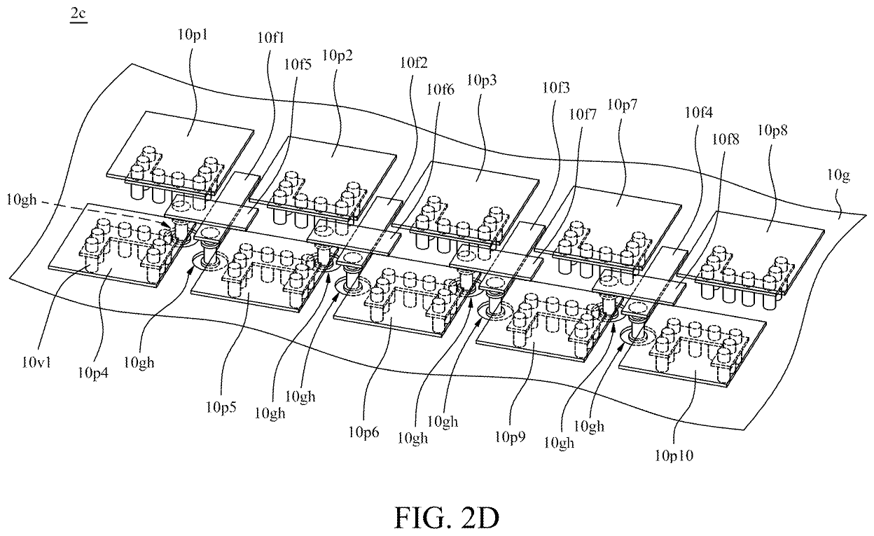

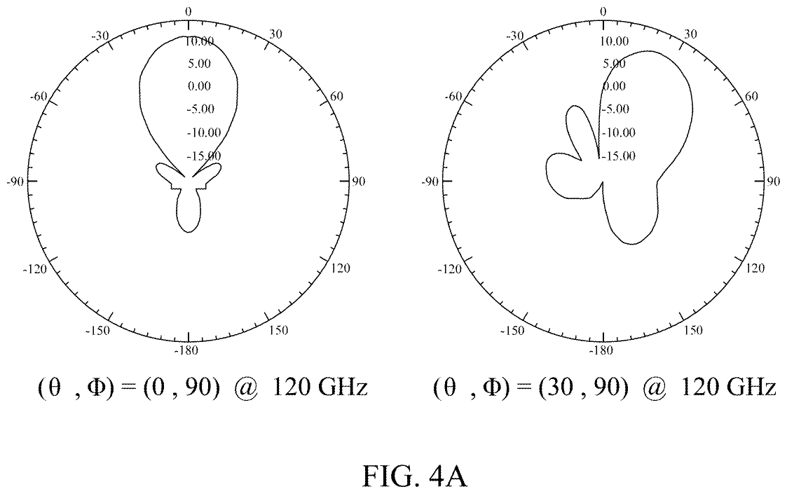

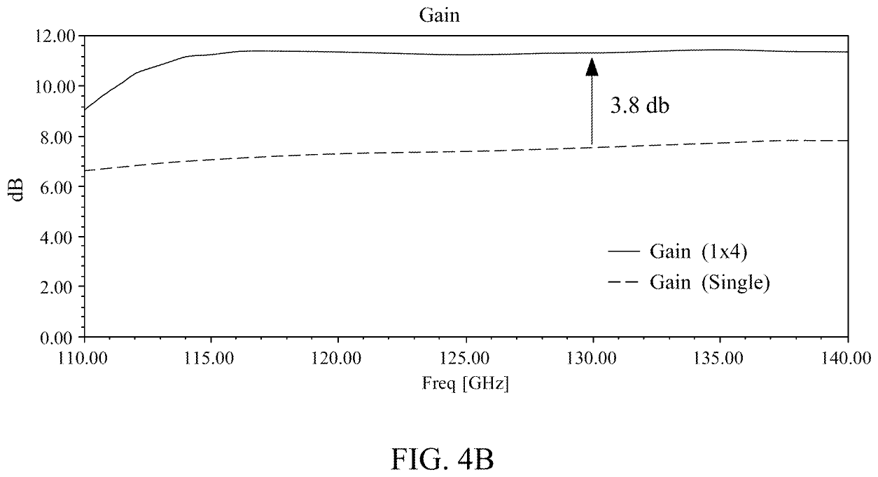

According to some arrangements of the present disclosure, the utilization of a common antenna plate design allows an increase in antenna gain while maintaining a smaller antenna array size compared to the traditional ME dipole antenna array. This satisfies demands for miniaturization. Simulation data in FIG. 4B demonstrates that the common antenna plate design (in 1×4 array, as shown in FIG. 2A) achieves a gain increase of 3.8 dB compared to a single ME dipole. In addition, from the simulated antenna gain pattern in FIG. 4A, it can be seen that the common antenna plate design (in 1×4 array, as shown in FIG. 2A) helps to increase directionality and coverage area of the antenna.

Furthermore, connecting the common antenna plate to a grounding plane reduces interference between feeding lines. This leads to improved signal quality and reliability without the need for increased package size.

Additionally, the common plate design offers the flexibility to adjust impedance according to different frequency and bandwidth requirements. This enhances design flexibility without increasing the overall area.

FIGS. 1G, 1H, and 1I illustrate other exemplary arrangements of the conductive vias 10v1 from top views, in accordance with an arrangement of the present disclosure. In FIG. 1G, the conductive vias 10v1 of the patterns 10p1, 10p3, 10p4, and 10p6 are located along sides of a corner of the patterns 10p1, 10p3, 10p4, and 10p6.

In FIG. 1H, the conductive vias 10v1 of the patterns 10p1, 10p3, 10p4, and 10p6 are positioned in a T shape, with one vertical line intersecting one horizontal line. In FIG. 1H, the conductive vias 10v1 of the patterns 10p2 and 10p5 are positioned in an H configuration, with two vertical lines intersecting one horizontal line. In some arrangements, the H configuration may reduce the interference between the patterns 10p1 and 10p3.

In FIG. 1I, the conductive vias 10v1 of the patterns 10p1, 10p2, 10p3, 10p4, 10p5, and 10p6 are positioned in an H configuration, with two vertical lines intersecting one horizontal line.

FIG. 2A is a top view of an electronic device 2a, in accordance with an arrangement of the present disclosure. The electronic device 2a is similar to the electronic device 1a in FIG. 1B, with differences therebetween as follows.

The electronic device 2a further includes patterns 10p7, 10p8, 10p9, 10p10, and feeding elements 10f3, 10f4.

The patterns 10p3, 10p7, 10p6, and 10p9 and the feeding element 10f3 may be a part of an antenna 16. The patterns 10p3, 10p7, 10p6, and 10p9 and the feeding element 10f3 may be collectively configured to form the antenna 16. The antenna 16 may include an ME dipole antenna.

The patterns 10p7, 10p8, 10p9, and 10p10 and the feeding element 10f4 may be a part of an antenna 17. The patterns 10p7, 10p8, 10p9, and 10p10 and the feeding element 10f4 may be collectively configured to form the antenna 17. The antenna 17 may include an ME dipole antenna. In some arrangements, the antennas 14, 15, 16, and 17 may form a beamforming antenna structure.

The antenna 14, antenna 15, the antenna 16, and the antenna 17 may be arranged along an x axis. The feeding elements 10f1, 10f2, 10f3, and 10f4 may be arranged along a y axis, which may be substantially perpendicular to the x axis. For example, the feeding elements 10f1, 10f2, 10f3, and 10f4 may each have a longer side and a shorter side, with the longer side arranged along the y axis. For example, the feeding elements 10f1, 10f2, 10f3, and 10f4 may each have a longer side and a shorter side, with the shorter side arranged along the x axis. The patterns 10p1, 10p2, 10p3, 10p7, and 10p8 are arranged along the x axis. The patterns 10p4, 10p5, 10p6, 10p9, and 10p10 are arranged along the x axis. The feeding elements 10f1, 10f2, 10f3, and 10f4 may each be overlapped with the patterns 10p1 through 10p10 along the x axis.

The antenna 15 and the antenna 16 may include common patterns. The antenna 15 and the antenna 16 may share common patterns. For example, pattern 10p3 and pattern 10p6 may be common patterns of the antenna 15 and the antenna 16. For example, pattern 10p3 and pattern 10p6 may be shared by the antenna 15 and the antenna 16. For example, pattern 10p3 and pattern 10p6 may both be a part of the antenna 15 and a part of the antenna 16. For example, pattern 10p3 and pattern 10p6 may both be capable of being excited by the feeding element 10f2. For example, pattern 10p3 and pattern 10p6 may both be capable of being excited by the feeding element 10f3.

The antenna 16 and the antenna 17 may include common patterns. The antenna 16 and the antenna 17 may share common patterns. For example, pattern 10p7 and pattern 10p9 may be common patterns of the antenna 16 and the antenna 17. For example, pattern 10p7 and pattern 10p9 may be shared by the antenna 16 and the antenna 17. For example, pattern 10p7 and pattern 10p9 may both be a part of the antenna 16 and a part of the antenna 17. For example, pattern 10p7 and pattern 10p9 may both be capable of being excited by the feeding element 10f3. For example, pattern 10p7 and pattern 10p9 may both be capable of being excited by the feeding element 10f4.

FIG. 2B is a top view of an electronic device 2b, in accordance with an arrangement of the present disclosure. The electronic device 2b is similar to the electronic device 2a in FIG. 2A except that the feeding elements 10f5, 10f6, 10f7, and 10f8 may be arranged along the x axis.

For example, the antenna 14, antenna 15, the antenna 16, and the antenna 17 may be arranged along the x axis. The feeding elements 10f5, 10f6, 10f7, and 10f8 may be arranged along the same direction. For example, the feeding elements 10f5, 10f6, 10f7, and 10f8 may each have a longer side and a shorter side, with the longer side arranged along the x axis. For example, the feeding elements 10f5, 10f6, 10f7, and 10f8 may each have a longer side and a shorter side, with the shorter side arranged along the y axis.

The shape and orientation of the feeding elements may be chosen based on factors of the EM waves, which may include resonant frequency, impedance, admittance (the reciprocal of impedance), phase, wavelength, etc.

FIG. 2C is a top view of an electronic device 2c, in accordance with an arrangement of the present disclosure. The electronic device 2c is a combination of the electronic device 2a in FIG. 2A and the electronic device 2b in FIG. 2B.

Using more feeding elements can lead to a more uniform distribution of the EM fields, which can improve antenna performance. Furthermore, the number of feeding lines can also affect the impedance matching of the ME dipole antennas. By adjusting the number of feeding elements, it is possible to optimize the impedance matching of the ME dipole antennas, which can improve their efficiency and performance.

The antennas 14, 15, 16, and 17 in FIG. 2C may include dual-polarized antennas. In a dual-polarized antenna, the electric field may be oriented in two perpendicular directions, such as horizontal and vertical. The antennas 14, 15, 16, and 17 may transmit and receive EM waves in two different directions (or in two orthogonal polarizations) simultaneously. This allows for increased signal quality and efficiency in a more compact design.

FIG. 2D is a perspective view of the electronic device 2c in FIG. 2C, in accordance with an arrangement of the present disclosure. The feeding elements 10f1 and 10f5 may be located at a different horizontal level with respect to the grounding plane 10g. The feeding elements 10f1 and 10f5 may be at least partially vertically overlapped. The feeding elements 10f1 and 10f5 may be substantially orthogonal to each other. The feeding elements 10f2 and 10f6 may be located at a different horizontal level with respect to the grounding plane 10g. The feeding elements 10f2 and 10f6 may be at least partially vertically overlapped. The feeding elements 10f2 and 10f6 may be substantially orthogonal to each other. The feeding elements 10f3 and 10f7 may be located at a different horizontal level with respect to the grounding plane 10g. The feeding elements 10f3 and 10f7 may be at least partially vertically overlapped. The feeding elements 10f3 and 10f7 may be substantially orthogonal to each other. The feeding elements 10f4 and 10f8 may be located at a different horizontal level with respect to the grounding plane 10g. The feeding elements 10f4 and 10f8 may be at least partially vertically overlapped. The feeding elements 10f4 and 10f8 may be substantially orthogonal to each other.

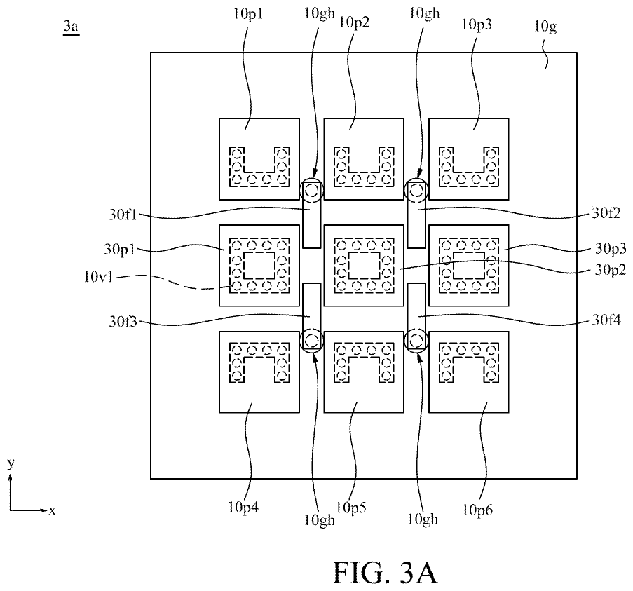

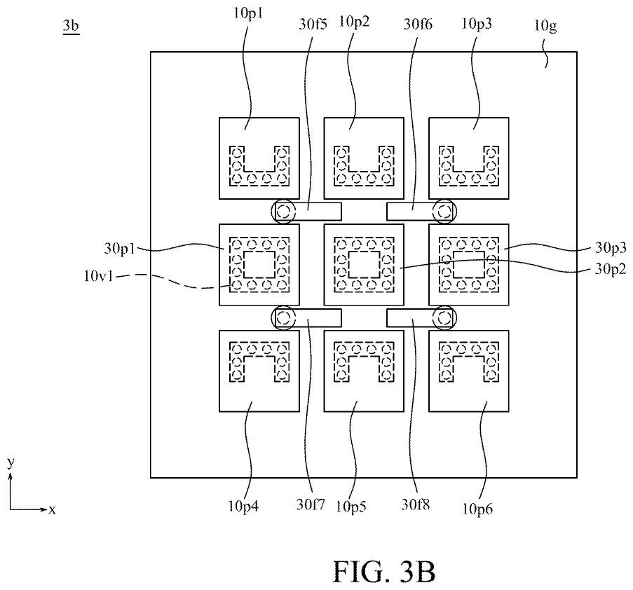

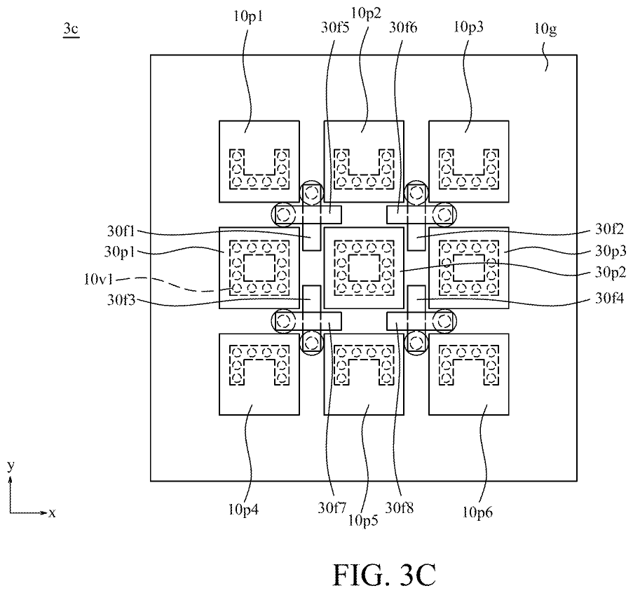

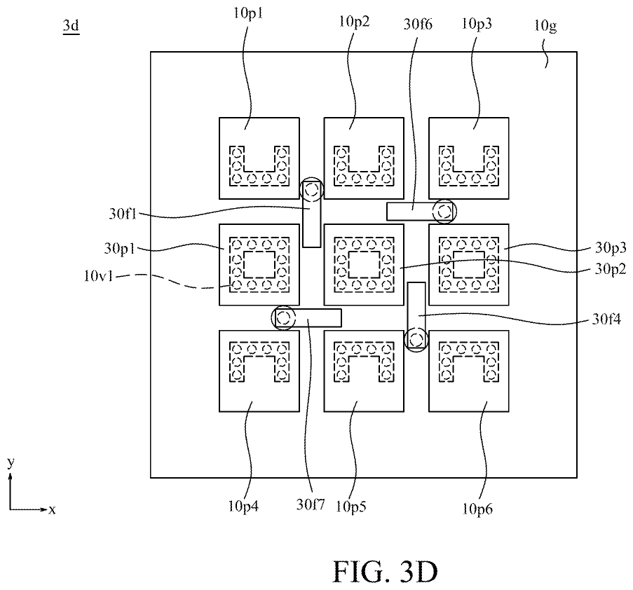

FIGS. 3A, 3B, 3C, and 3D illustrate top views of electronic devices including patterns arranged in a 3×3 array, in accordance with an arrangement of the present disclosure.

In the electronic device 3a of FIG. 3A, the feeding element 30f1 and the four patterns around the feeding element 30f1 may be a part of an antenna or may be collectively configured to form an antenna, such as an ME dipole antenna. The feeding element 30f2 and the four patterns around the feeding element 30f2 may be a part of an antenna or may be collectively configured to form an antenna, such as an ME dipole antenna. The feeding element 30f3 and the four patterns around the feeding element 30f3 may be a part of an antenna or may be collectively configured to form an antenna, such as an ME dipole antenna. The feeding element 30f4 and the four patterns around the feeding element 30f4 may be a part of an antenna or may be collectively configured to form an antenna, such as an ME dipole antenna. In some arrangements, the antennas of FIG. 3A may form a beamforming antenna structure.

The conductive vias of the patterns 30p1, 30p2, and 30p3 may located along four sides of the patterns 30p1, 30p2, and 30p3. The patterns 30p1 and 30p3 may be the common pattern of two antennas. The pattern 30p2 at the center may be the common pattern of four antennas. The feeding elements 30f1, 30f2, 30f3, and 30f4 may be arranged along the y axis.

In the electronic device 3b of FIG. 3B, the feeding elements 30f5, 30f6, 30f7, and 30f8 may be arranged along the x axis.

In the electronic device 3c of FIG. 3C, the feeding elements 30f1, 30f2, 30f3, and 30f4 in FIG. 3A and the feeding elements 30f5, 30f6, 30f7, and 30f8 in FIG. 3B may be combined. The antennas in FIG. 3C may include dual-polarized antennas.

In the electronic device 3d of FIG. 3D, the feeding elements 30f1 and 30f4 in FIG. 3A the feeding elements 30f6 and 30f7 in FIG. 3B may be combined or selectively used. The feeding elements 30f1, 30f4, 30f6, and 30f7 are orthogonal to each other, and they excite EM waves with a phase difference of 90°, resulting in a circularly polarized radiation pattern.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of arrangements of this disclosure are not deviated from by such an arrangement.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1, less than or equal to ±0.5°, less than or equal to ±0.1°, or less than or equal to ±0.05°.

Two surfaces can be deemed to be coplanar or substantially coplanar if a displacement between the two surfaces is no greater than 5 μm, no greater than 2 μm, no greater than 1 μm, or no greater than 0.5 μm. A surface can be deemed to be substantially flat if a displacement between a highest point and a lowest point of the surface is no greater than 5 μm, no greater than 2 μm, no greater than 1 μm, or no greater than 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity greater than approximately 104 S/m, such as at least 105 S/m or at least 106 S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a first pattern;
a second pattern adjacent to the first pattern; and
a third pattern disposed between the first pattern and the second pattern,
a first feeding element spaced apart from the first pattern and the third pattern and configured to electrically couple the first pattern and the third pattern to constitute a first antenna; and
a second feeding element configured to electrically couple the second pattern and the third pattern to constitute a second antenna.

2. The electronic device of claim 1, wherein the first antenna and the second antenna are configured to constitute a beamforming antenna structure.

3. The electronic device of claim 1, wherein the first feeding element is disposed between the first pattern and the third pattern.

4. The electronic device of claim 1, wherein the first feeding element is disposed at a different elevation from the third pattern and the first pattern.

5. The electronic device of claim 1, wherein the first feeding element is not vertically overlapped with the third pattern and the first pattern.

6. The electronic device of claim 1, wherein the third pattern and the first pattern are geometrically similar.

7. The electronic device of claim 1, further comprising:
a fourth pattern; and
a fifth pattern adjacent to the fourth pattern;
wherein the first feeding element is spaced apart from the fourth pattern and the fifth pattern and configured to electrically couple the fourth pattern and the fifth pattern to constitute the first antenna with the first pattern and the third pattern.

8. The electronic device of claim 7, wherein the first pattern and the third pattern are arranged along a direction, and the first feeding element is overlapped with the first pattern, the third pattern, the fourth pattern, and the fifth pattern in the direction.

9. The electronic device of claim 1, wherein a distance between the first feeding element and the second feeding element is less than a half-wavelength of an operating frequency of the first antenna or less than a half-wavelength of an operating frequency of the second antenna.

10. The electronic device of claim 1, further comprising:
a third feeding element spaced apart from the first pattern and configured to electrically couple the first pattern and the third pattern to constitute the first antenna.

11. The electronic device of claim 10, wherein the first feeding element and the third feeding element are at least partially vertically overlapped.

12. The electronic device of claim 11, wherein the first feeding element and the third feeding element are substantially orthogonal to each other.

13. The electronic device of claim 10, wherein the first feeding element and the third feeding element are disposed at different elevations from the first pattern.

14. An electronic device, comprising:
a first pattern connected to a grounding element;
a second pattern adjacent to the first pattern, wherein the first pattern and the second pattern are configured to constitute a first antenna; and
a third pattern adjacent to the first pattern, wherein the first pattern and the third pattern are configured to constitute a second antenna,
wherein the first antenna and the second antenna are configured to constitute a beamforming antenna structure.

15. The electronic device of claim 14, wherein the second pattern and the third pattern are arranged along a first direction, and the electronic device further comprises a plurality of grounding elements arranged in a second direction substantially perpendicular with the first direction.

16. The electronic device of claim 14, further comprising:
a first feeding element disposed between the first pattern and the second pattern, wherein the first feeding element has a portion extends exceed a lateral side of the first pattern.

17. The electronic device of claim 16, further comprising:
a conductive element connecting with the portion and configured to feed a signal to the first feeding element.

18. The electronic device of claim 14, further comprising:
a grounding plane disposed below the first pattern and connecting with the first pattern through a conductive wire.

19. An electronic device, comprising:
a first magneto-electric (ME) dipole antenna having a conductive pattern; and
a second magneto-electric (ME) dipole antenna, wherein the conductive pattern configured to serve as a portion of the second ME dipole antenna.

20. The electronic device of claim 19, wherein an EM wave of the first ME dipole antenna and an EM wave of the second ME dipole antenna are configured to interact with each other in a far field region.
